(19) United States
(12) Patent Application Publication
(10) Pub. No.: US 2014/0372923 A1
(43) Pub. Date: Dec. 18, 2014

(54) High Performance Touch Drag and Drop

(71) Applicant: Microsoft Corporation, Redmond, WA (US)

(72) Inventors: Jacob S. Rossi, Seattle, WA (US); John Wesley Terrell, Kirkland, WA (US); Fei Xiong, Redmond, WA (US); Michael J. Ens, Redmond, WA (US); Xiao Tu, Medina, WA (US); Nicolas J. Brun, Seattle, WA (US); Ming Huang, Bellevue, WA (US); Jan-Kristian Markiewicz, Redmond, WA (US); Alan William Stephenson, Redmond, WA (US); Michael John Patten, Sammamish, WA (US); Jon Gabriel Clapper, Seattle, WA (US)

(21) Appl. No.: 13/918,645

(22) Filed: Jun. 14, 2013

(51) Int. Cl. G06F 3/0486; G06F 3/0488

(52) U.S. Cl. CPC G06F 3/0486; G06F 3/0488
USPC 715/769

(57) ABSTRACT

High performance touch drag and drop are described. In embodiments, a multi-threaded architecture is implemented to include at least a manipulation thread and an independent hit test thread. The manipulation thread is configured to receive one or more messages associated with an input and send data associated with the messages to the independent hit test thread. The independent hit test thread is configured to perform an independent hit test to determine whether the input hit an element that is eligible for a particular action, and identify an interaction model associated with the input. The independent hit test thread also sends an indication of the interaction model to the manipulation thread to enable the manipulation thread to detect whether the particular action is triggered.

### BACKGROUND

One of the challenges that continues to face designers of devices having user-engageable displays, such as touch displays, pertains to providing enhanced functionality for users, through gestures that can be employed with the devices. This is so, not only with devices having larger or multiple screens, but also in the context of devices having a smaller footprint, such as tablet PCs, hand-held devices, smaller multi-screen devices and the like.

One challenge with gesture-based input is that of providing a web platform that enables functionalities for mouse input to enable similar functionalities for touch input. For example, in touch interfaces today, it is common to tap on an item to launch the item. This makes it difficult to provide secondary functionality such as an ability to select items. Further, certain challenges exist with so-call pannable surfaces, i.e. surfaces that can be panned and have their content moved. For example, a pannable surface typically reacts to a finger drag and moves the content in the direction of the user's finger. If the surface contains objects that a user might want to re-arrange, it is difficult to differentiate when the user wants to pan the surface or re-arrange the content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for high performance touch drag and drop are described. In at least some embodiments, a multi-threaded architecture is implemented to include at least a manipulation thread and an independent hit test thread. The manipulation thread receives messages associated with an input, and sends data associated with the messages to the independent hit test thread. The independent hit test thread performs an independent hit test to determine whether the input hit an element that is eligible for a particular action. The independent hit test thread also identifies an interaction model associated with the input, and sends an indication of the interaction model to the manipulation thread to enable the manipulation thread to detect whether the particular action is triggered.

In one or more embodiments, one or more manipulation notifications based on a pointer message associated with a touch input are received. The pointer message is configured to initiate a drag and drop operation on an element of a page. Updates associated with the pointer message are correlated with a drag visual that represents the element on the page. One or more drag notifications are sent to a drag drop manager to enable the drag drop manager to initiate mouse-compatible functionalities without having to understand the touch input.

In at least some embodiments, a request to load a page is received, and one or more draggable elements on the page are identified. The draggable elements are rendered on the page into a layer that is separate from another layer into which content on the page is rendered. An input to initiate a drag and drop operation on a draggable element is received. Responsive to the drag and drop operation being initiated, a drag visual is rendered based on the draggable element.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 is a flow diagram that describes steps in a method in accordance with one or more embodiments.

FIG. 4 illustrates an example client architecture in accordance with one or more embodiments.

FIG. 5 is a flow diagram that describes steps in a method in accordance with one or more embodiments.

FIG. 6 is an illustration of an example implementation in accordance with one or more embodiments.

FIG. 7 is a flow diagram that describes steps in a method in accordance with one or more embodiments.

FIG. 8 illustrates an example architecture for receiving and processing mouse and touch inputs in accordance with one or more embodiments.

FIG. 9 is a flow diagram that describes steps in an input transformation process or method in accordance with one or more embodiments.

FIG. 10 illustrates a system showing an example implementation that is operable to employ automatic scrolling for a touch input in accordance with one or more embodiments.

FIG. 11 is a flow diagram that describes steps in a method in accordance with one or more embodiments.

FIG. 12 illustrates an example computing device that can be utilized to implement various embodiments described herein.

### DETAILED DESCRIPTION

Overview

High performance drag and drop operations for touch displays are described. In at least some embodiments, cross-slide gestures can be used on content that pans or scrolls in one direction, to enable additional actions, such as content selection, drag and drop operations, and the like. In at least some other embodiments, press-and-hold gestures can be used on elements to enable content selection, drag and drop operations, and the like.

Typical web browsers may enable drag and drop functionality as a means to move, rearrange, or copy elements with a mouse. Generally, this functionality is enabled via a standardized Hypertext Markup Language 5 (HTML5) Drag and Drop application programming interface (API). However, these web browsers generally lack similar drag and drop functionality for touch input. Further, some web browsers do not disambiguate a drag operation versus a scroll operation.

Various embodiments enable disambiguation between a drag action and a scroll (e.g., pan) action by using a cross-slide gesture or a press-and-hold gesture. In at least some embodiments, stick-to-your-finger performance is enabled, independent of the application or web page code running in parallel. This is achieved, in at least some embodiments, via a multi-threaded architecture that is configured to manipulate drag visuals on one thread while providing input events on another thread.

In at least some embodiments, a drag visual can be created generally contemporaneously upon the start of a gesture by pre-layering the drag visual and also enforcing z-order and visual duplication of the element for the drag visual during touch manipulation. These enhancements can provide for a smooth transition from rendering the element to rendering the drag visual.

In one or more embodiments, independent automatic scrolling can be enabled for scrolling regions while dragging an element. Automatic scrolling may be initiated responsive to the user dragging the element near an edge of the scrolling region. If the user drags the element into a region within a distance threshold, the scrollable region may begin to automatically scroll in that edge direction. In at least some embodiments, multi-touch interactions enable the user to drag the element with a first finger and, during the drag, use a second finger to scroll the page behind the element being dragged.

Further, at least some embodiments enable an item to be dragged without necessarily entering a mode. A mode can be thought of as an action that is initiated by a user that is not necessarily related to manipulating an item directly. For example, a mode can be entered by clicking on a particular user interface button to then be exposed to functionality that can be performed relative to an item or object. In the described embodiments, modes can be avoided by eliminating, in at least some instances, user interface elements to access drag functionality.

In yet other embodiments, applications that use drag and drop APIs designed for mouse input may automatically function with touch input without the applications having touch-specific code. Various embodiments described herein can map touch input events to drag events that are typically used for mouse input. In addition, embodiments described herein can map multi-touch input, which is not generally possible with a mouse.

In the following discussion, an example environment is first described that is operable to employ the gesture techniques described herein. Example illustrations of the gestures and procedures are then described, which may be employed in the example environment, as well as in other environments. Accordingly, the example environment is not limited to performing the example gestures and the gestures are not limited to implementation in the example environment.

### Example Environment

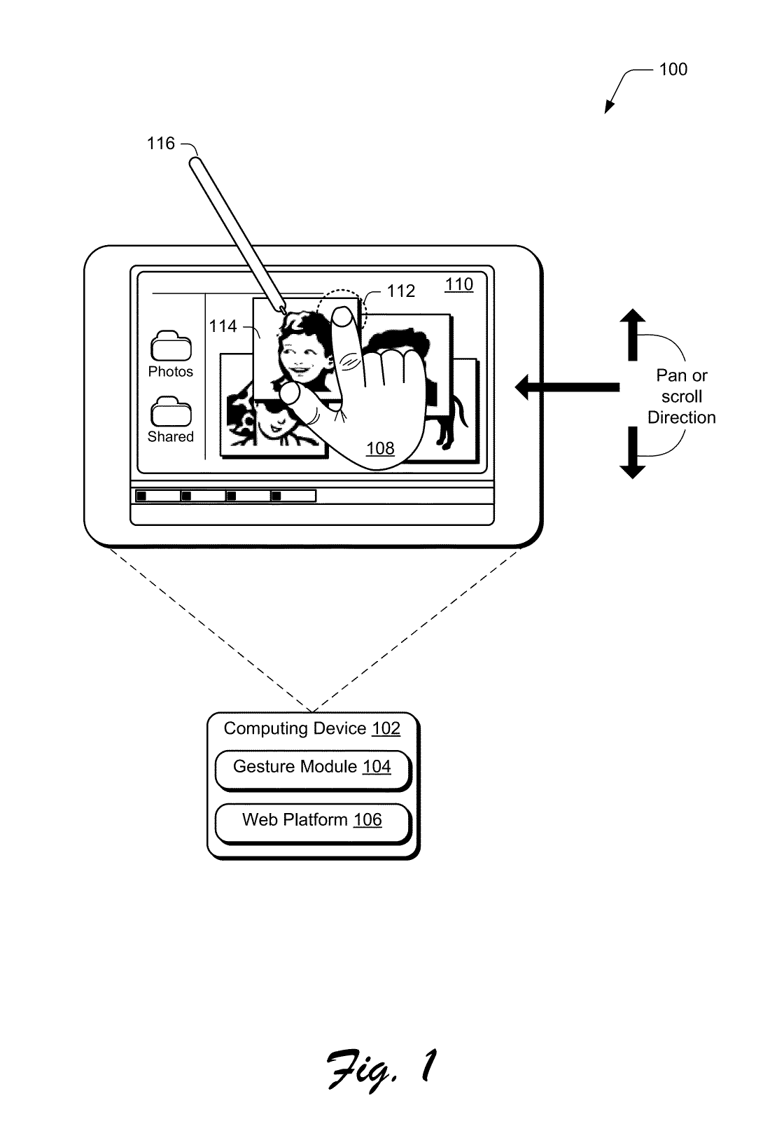

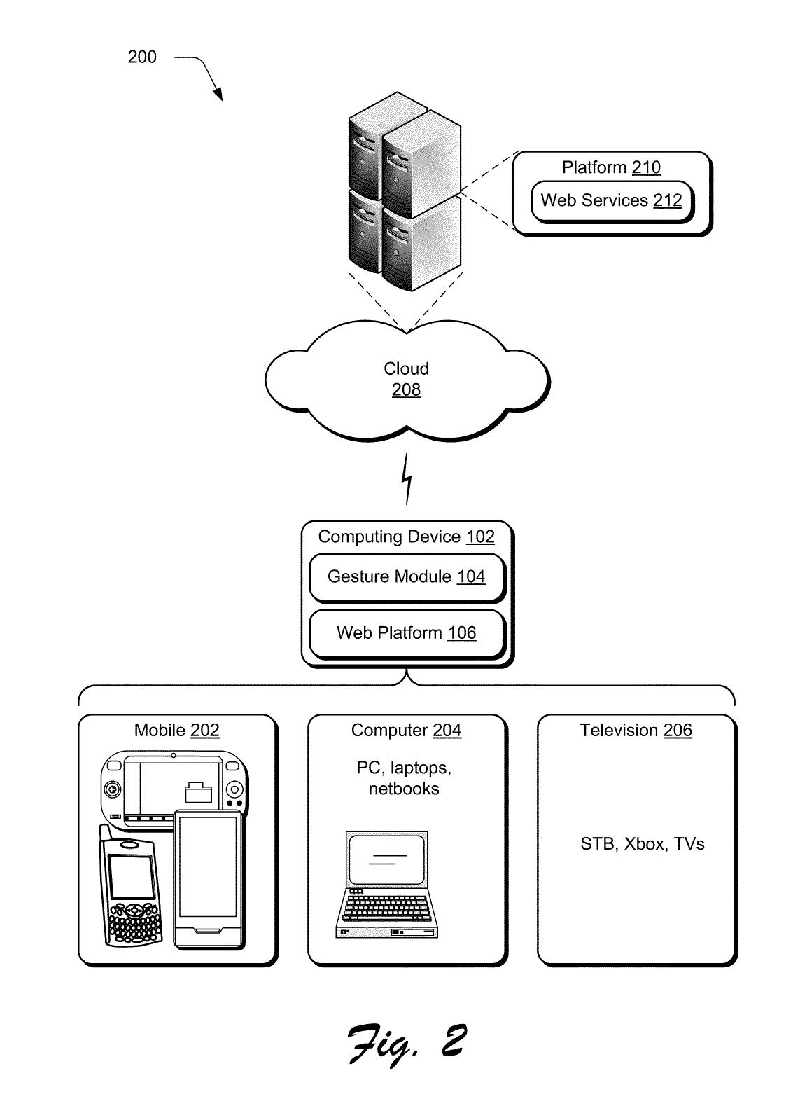

FIG. 1 is an illustration of an environment 100 in an example implementation that is operable to employ high performance touch drag and drop operations as described herein. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a gesture module 104 and a web platform 106. The gesture module 104 is operational to provide gesture functionality as described in this document. The gesture module 104 can be implemented in connection with any suitable type of hardware, software, firmware or combination thereof. In at least some embodiments, the gesture module 104 is implemented in software that resides on some type of computer-readable storage medium examples of which are provided below.

Gesture module 104 is representative of functionality that recognizes gestures, including drag-and-drop gestures that can be performed by one or more fingers, and causes operations to be performed that correspond to the gestures. The gestures may be recognized by module 104 in a variety of different ways. For example, the gesture module 104 may be configured to recognize a touch input, such as a finger of a user's hand 108 as proximal to display device 110 of the computing device 102 using touchscreen functionality. In particular, gesture module 104 can recognize non-scrolling gestures used on scrollable content to enable non-scrolling actions, such as content selection, drag and drop operations, and the like.

For instance, in the illustrated example, a pan or scroll direction is shown as being in the vertical direction, as indicated by the arrows. In one or more embodiments, a cross-slide gesture can be performed such as is described in U.S. patent application Ser. No. 13/196,272 entitled “Cross-slide Gesture to Select and Rearrange”. For example, a cross-slide gesture can be performed by dragging an item or object in a direction that is different, e.g. orthogonal, from the panning or scrolling direction. The different-direction drag can be mapped to additional actions or functionality. With respect to whether a direction is vertical or horizontal, a vertical direction can be considered, in at least some instances, as a direction that is generally parallel to one side of a display device, and a horizontal direction can be considered as a direction that is generally orthogonal to the vertical direction. Hence, while the orientation of a computing device may change, the verticality or horizontally of a particular cross-slide gesture can remain standard as defined relative to and along the display device.

For example, a finger of the user's hand 108 is illustrated as selecting 112 an image 114 displayed by the display device 110. Selection 112 of the image 114 and subsequent movement of the finger of the user's hand 106 in a direction that is different from the pan or scroll direction, e.g., generally orthogonal relative to the pan or scroll direction, may be recognized by the gesture module 104. The gesture module 104 may then identify this recognized movement, by the nature and character of the movement, as indicating a “drag and drop” operation to change a location of the image 114 to a point in the display at which the finger of the user's hand 108 is lifted away from the display device 110. Thus, recognition of the touch input that describes selection of the image, movement of the selection point to another location, and then lifting of the finger of the user's hand 106 may be used to identify a gesture (e.g., drag-and-drop gesture) that is to initiate the drag and drop operation.

Although cross-slide gestures are discussed in the above example, it is to be appreciated and understood that a variety of different types of gestures may be recognized by the gesture module 104 including, by way of example and not limitation, gestures that are recognized from a single type of input (e.g., touch gestures such as the previously described drag-and-drop gesture) as well as gestures involving multiple types of inputs. For example, module 104 can be utilized to recognize single-finger gestures and bezel gestures, multiple-finger/same-hand gestures and bezel gestures, and/or multiple-finger/different-hand gestures and bezel gestures.

For example, the computing device 102 may be configured to detect and differentiate between a touch input (e.g., provided by one or more fingers of the user's hand 108) and a stylus input (e.g., provided by a stylus 116). The differentiation may be performed in a variety of ways, such as by detecting an amount of the display device 110 that is contacted by the finger of the user's hand 108 versus an amount of the display device 110 that is contacted by the stylus 116.

Thus, the gesture module 104 may support a variety of different gesture techniques through recognition and leverage of a division between stylus and touch inputs, as well as different types of touch inputs.

The web platform 106 is a platform that works in connection with content of the web, e.g. public content. A web platform 106 can include and make use of many different types of technologies such as, by way of example and not limitation, URLs, HTTP, REST, HTML, CSS, JavaScript, DOM, and the like. The web platform 106 can also work with a variety of data formats such as XML, JSON, and the like. Web platform 106 can include various web browsers, web applications (i.e. “web apps”), and the like. When executed, the web platform 106 allows the computing device to retrieve web content such as electronic documents in the form of webpages (or other forms of electronic documents, such as a document file, XML file, PDF file, XLS file, etc.) from a Web server and display them on the display device 110. It should be noted that computing device 102 could be any computing device that is capable of displaying Web pages/documents and connect to the Internet.

FIG. 2 illustrates an example system showing the gesture module 104 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, tablets, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks. For example, the gesture module 104 may be implemented in part on the computing device 102 as well as via a platform 210 that supports web services 212.

For example, the gesture techniques supported by the gesture module may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

For example, the computing device may also include an entity (e.g., software) that causes hardware or virtual machines of the computing device to perform operations, e.g., processors, functional blocks, and so on. For example, the computing device may include a computer-readable medium that may be configured to maintain instructions that cause the computing device, and more particularly the operating system and associated hardware of the computing device to perform operations. Thus, the instructions function to configure the operating system and associated hardware to perform the operations and in this way result in transformation of the operating system and associated hardware to perform functions. The instructions may be provided by the computer-readable medium to the computing device through a variety of different configurations.

One such configuration of a computer-readable medium is a signal bearing medium and thus is configured to transmit the instructions (e.g., as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

In the discussion that follows, various sections describe example cross-slide and press-and-hold gestures including re-arrange gestures. A section entitled “Method/Gesture for Disambiguating Touch Pan and Touch Drag” describes a drag-and-drop gesture that can be executed without removing an ability to pan or scroll in accordance with one or more embodiments. Next, a section entitled “Multi-Threaded Architecture” describes an architecture that allows visuals to be manipulated on one thread while providing input events on another thread in accordance with one or more embodiments. Following this, a section entitled “Pre-layering” describes how a visual representation of a draggable element can be dragged virtually immediately upon initiating the drag operation in accordance with one or more embodiments. Next, a section entitled “Method/Gesture for Independent Automatic Scrolling” describes how scrolling is triggered when an element is dragged near the edges of a scrollable region in accordance with one or more embodiments. Following this, a section entitled “Smooth Transitions of Z-Order” describes how, responsive to the gesture being triggered, a drag visual is produced for a user to drag around in accordance with one or more embodiments. Next, a section entitled “Mapping of Touch Input to Mouse-Intended Drag Drop APIs” describes embodiments in which applications that use drag drop APIs designed for mouse input can automatically function for touch inputs in accordance with one or more embodiments. Last, a section entitled “Example Device” describes aspects of an example device that can be utilized to implement one or more embodiments.

Method/Gesture for Disambiguating Touch Pan and Touch Drag

Traditional drag and drop functionality provided via web browsers are generally based on basic drag and drop events and were typically designed for mouse input in connection with mouse messages. Drag and drop functionality may not function properly in a touch input environment that uses pointer messages rather than mouse messages.

In order to disambiguate between panning, selecting, and rearranging (drag and drop), various touch inputs may be utilized. In one embodiment, a drag operation can be initiated by a touch input, such as a cross-slide gesture or press-and-hold gesture. A press-and-hold gesture may be performed by a user pressing on a drag-enabled element and holding the gesture steady for a duration of time that exceeds a drag threshold. Any suitable drag threshold may be utilized. Responsive to exceeding the drag threshold, a drag and drop operation is triggered, a new drag visual is produced, and the user may freely drag the drag visual to a new location on the page.

In at least some embodiments, a drag operation may be initiated by a cross-slide gesture, as described above. For example, a web page or application may restrict panning to a single axis and allow dragging in an axis that is different, e.g., orthogonal, from the panning axis. A cross-slide gesture may be performed by a user swiping a finger on a draggable element on the axis that is different than the panning axis. The cross-slide gesture may initiate one of at least two different functions, depending on whether the finger swipe exceeds a distance threshold. Any suitable distance threshold may be utilized. By way of example and not limitation, a distance threshold of about 2.7 mm may be used to initiate a drag and drop operation. On the other hand, if the finger swipe does not exceed the distance threshold, another function may be performed, such as selection of the draggable element.

Some web browsers and applications, however, generally provide overflow in a vertical direction and back/forward navigation panning in a horizontal direction, or a direction that is substantially orthogonal to the panning direction. This presents a conflict as to whether a drag operation or a pan operation should occur when sliding a finger on an element. As an example, consider a web site that provides vertical swiping for panning a list of files and horizontal swiping for triggering the browser's back/forward navigation. This web site may present a challenge for typical cross-slide gestures because a sliding gesture in either the vertical or horizontal direction would initiate a panning operation or a back/forward navigation, respectively, rather than an operation to select and drag an element. To overcome such challenges, the web site may utilize the press-and-hold gesture, as described above, rather than the cross-slide gesture, for selection of elements.

In one embodiment, a visual indication may be provided to the user to indicate that a drag and drop operation has been successfully initiated and that the user may now freely drag the element. For example, the element may “pop” out in the page and follow the user's finger as the user's finger moves around the page, to give the appearance that the element is “sticking” to the user's finger. Alternatively or additionally, the element may fade out and then fade back in under the user's finger. In this way, the user is notified that a drag operation is being performed rather than a pan or selection operation.

In at least some embodiments, once a drag and drop operation has been initiated and the user is able to drag the element with a first finger, the user may then use one or more additional fingers or other touch input devices to initiate a secondary operation. For example, subsequent to exceeding the drag threshold using a first finger on a draggable element, a second finger may hit test a scrollable element to initiate panning while the first finger continues to drag. Accordingly, once the drag threshold has been achieved, a second contact is able to interact with other viewports as if the drag was not occurring, and thus avoid interrupting the drag operation. As an example, consider a user that wishes to drag an element from one location on the page, such as near the top of a document, to another location on the page that is not currently displayed, such as the near the bottom of the document. In this particular example, the user may use a press-and-hold gesture or a cross-slide gesture to initiate a drag and drop operation to “stick” the element to the user's finger, and then use a second finger to pan the page to another location where the user may drop the element.

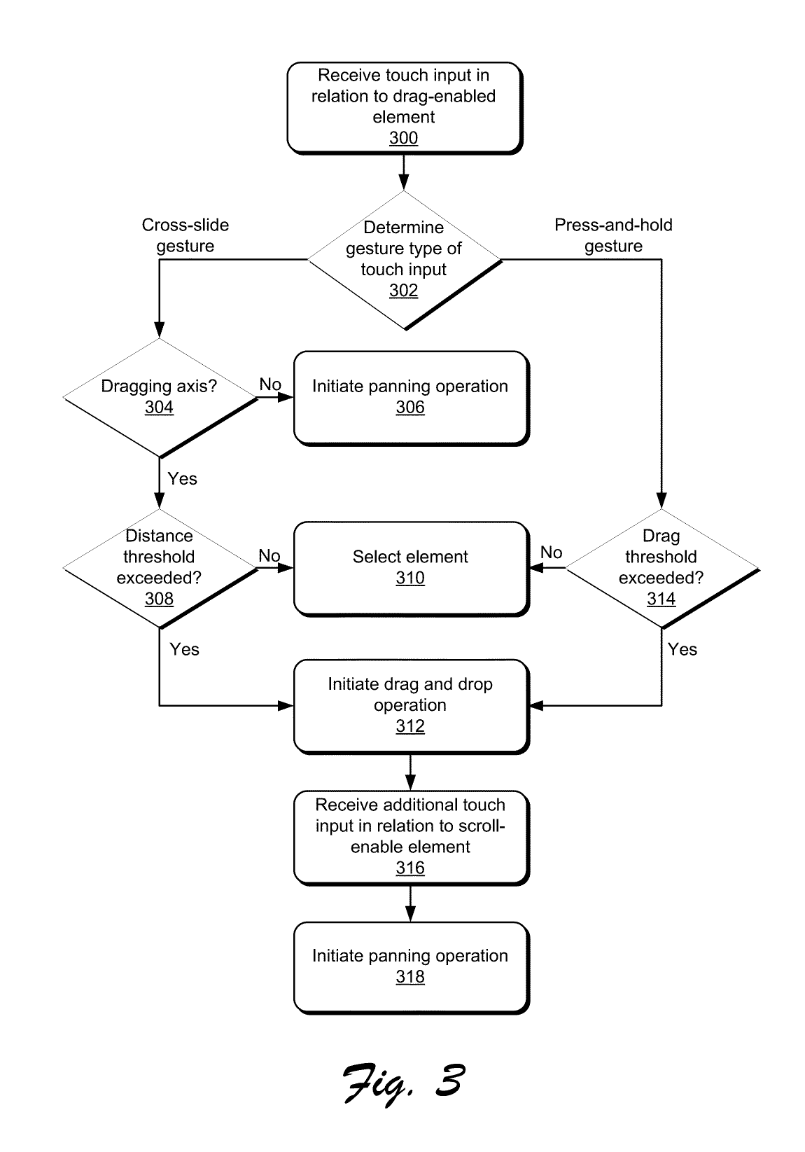

Consider now FIG. 3, which is a flow diagram that describes steps in a method in accordance with one or more embodiments. The method can be implemented in connection with any suitable hardware, software, firmware, or combination thereof. In at least some embodiments, the method can be implemented by a suitably-configured system, such as one that includes an independent hit test thread.

Step 300 receives a touch input in relation to a drag-enabled element. In at least some embodiments, the touch input comprises a cross-slide gesture or a press-and-hold gesture, as described above. Step 302 determines a gesture type of the input received in relation to the draggable element. If the gesture type is determined to be a cross-slide gesture on the draggable element, step 304 determines whether the cross-slide gesture is along a dragging axis. Any suitable dragging axis may be utilized. In at least one embodiment, the dragging axis is along a direction that is orthogonal to a panning or scrolling direction. If the cross-slide gesture is not along the dragging axis, then step 306 initiates a panning operation. On the other hand, if the cross-slide gesture includes a gesture along the dragging axis, then step 308 determines whether a distance threshold has been exceeded. Any suitable distance threshold may be utilized, such as a distance that a user's finger is swiped on the draggable element along the dragging axis. In one or more embodiments, a distance threshold of about 2.7 mm may be used to initiate a drag and drop operation.

If the distance threshold is not exceeded, step 310 selects the element. On the other hand, if the distance threshold has been exceeded by the finger swipe, the step 312 initiates a drag and drop operation. In at least one embodiment, the element “sticks” to the user's finger and the user may drag the element to a new location.

Returning to step 302, if the gesture type of the touch input is determined to be a press-and-hold gesture, then step 314 determines whether a drag threshold has been exceeded. Any suitable drag threshold may be utilized. In one embodiment, the drag threshold may include a predetermined period of time for which the press-and-hold gesture is held steady on the element. If the drag threshold is not exceeded, then step 310 selects the element. For example, the user may discontinue contact with the element prior to exceeding the drag threshold. On the other hand, if the drag threshold is exceeded, such that the user maintains the press-and-hold gesture steady for a duration of time that exceeds the drag threshold, then step 312 initiates the drag and drop operation, as described above.

Once the drag and drop operation is initiated, step 316 receives an additional touch input in relation to a scroll-enabled element. In one or more embodiments, the additional touch input is received in parallel with execution of the drag and drop operation on the drag-enabled element. For example, while the user is dragging the element with a first finger, the user may use a second finger on the scroll-enabled element to pan the page underneath the element being dragged. Responsive to receiving the additional touch input in relation to the scroll-enabled element, step 318 initiates a panning operation. Any suitable panning operation can be utilized. In an embodiment, the panning operation is initiated to pan the page concurrently with the drag-enabled element being dragged.

Having considered the above-described disambiguation techniques, consider now a discussion of a multi-threaded architecture in accordance with one or more embodiments.

Multi-Threaded Architecture

Using traditional techniques, such as a single-threaded architecture, intensive processing by web sites and applications may impact the ability to maintain an element under the user's finger while the element is being dragged. In one or more embodiments, a multi-threaded architecture is employed to provide independence between the application code and manipulation of the draggable element. In operation, an independent hit test component provides a hit test thread which is separate from a main thread, e.g. the user interface thread. The independent hit test thread is utilized for hit testing on web content that mitigates the effects of hit testing on the main thread. Using a separate thread for hit testing can allow targets to be quickly ascertained. In cases where the appropriate response is handled by a separate thread, such as a manipulation thread that can be used for touch manipulations such as panning and drag and drop operations, manipulation can occur without blocking on the main thread. This results in a response time that is consistently quick even on low-end hardware over a variety of scenarios. In at least some embodiments, the manipulation thread and the independent hit test thread may be the same thread, while separate from and independent of the UI thread.

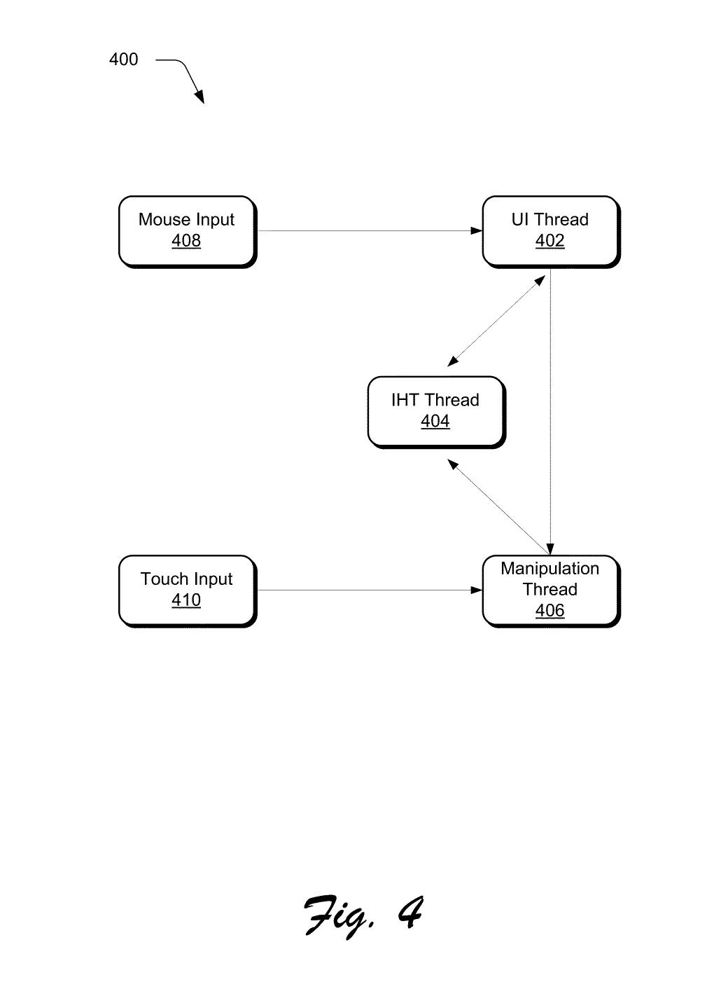

Consider now FIG. 4, which illustrates an example client architecture, generally at 400, in accordance with one or more embodiments. In this example, three different threads are illustrated at 402, 404, and 406. User interface thread 402 constitutes the main thread that is configured to house execution of the web app's or web site's code, including events and other APIs that expose drag and drop functionality. An independent hit test (IHT) thread 404 constitutes a thread that utilizes a data structure that represents manipulatable elements on a page, including draggable elements. Manipulation thread 406 constitutes the thread that is configured to accept touch input for the operating system and, based on manipulation configuration provided by the IHT thread, manipulates “viewports” into which page elements are rendered.

In one or more embodiments, independent hit testing can operate as follows. The independent hit test thread 404 is aware of regions on the displayed page which are independent and dependent. An “independent region” is a region of web content that does not have to utilize the main thread for hit testing. Independent regions typically include those regions that are normally panned or zoomed by a user. A “dependent region” is a region of web content that utilizes the main thread, i.e., the user interface thread, for hit testing. Dependent regions can be associated with input or “hits” that occur over a control such as <input type=“range”> where the interaction with the page does not trigger a manipulation. Other dependent regions can include, by way of example and not limitation, those associated with selection handlers, adorners, scrollbars, and controls for video and audio content. Such dependent regions can also include windowless ActiveX controls, where the intent of third-party code is not known.

When a user causes a mouse input 408 by, for example, clicking on a particular element, the mouse input 408 is received and processed at the UI thread 402. However, when a user causes a touch input 410, the touch input 410 is redirected to the manipulation thread 406, which is a separate thread from the UI thread 402, as described above. In at least some embodiments, the manipulation thread 406 serves as or manages a delegate thread that is registered to receive messages associated with various types of touch inputs. The manipulation thread 406 receives touch input messages and updates before the user interface thread 402. The IHT thread 404 is registered with the manipulation thread 406 to receive input messages from the manipulation thread 406. When a touch input 410 is received, the manipulation thread 406 receives an associated message and sends a synchronous notification to the IHT thread 404. The IHT thread 404 receives the message and uses data contained therewithin to walk an associated display tree to perform a hit test. The entire display tree can be walked or a scoped traversal can take place. If the touch input occurs relative to an independent region, the IHT thread 404 calls manipulation thread 406 to inform the manipulation thread 406 that it can initiate panning. In at least some embodiments, if the touch input occurs relative to a dependent region, then the manipulation thread 406 reassigns the input messages to the user interface thread 402 for processing by way of a full hit test. Reassigning the input messages to the user interface thread 402 carries with it efficiencies because the messages are kept in the same queue or location until reassignment occurs, thus keeping the message from being moved in the queue. Dependent regions that are not subject to manipulation based on an independent hit test include, by way of example and not limitation, those regions corresponding to elements including slider controls, video/audio playback and volume sliders, ActiveX controls, scrollbars, text selection grippers (and other adorners), and pages set to overflow.

In at least some embodiments, after an independent hit test is performed or during initiation of the manipulation, the input message that spawned the independent hit test is forwarded to the user interface thread 402 for normal processing. Normal processing is associated with basic interactions such as, by way of example and not limitation, processing that can apply various styles to elements that are the subject of the input. In these instances, forwarding the input message to the user interface thread 402 does not block manipulation performed by the manipulation thread 406.

In operation, the web platform 106, such as a browser or web application host, may expose one or more APIs that are configured for drag and drop functionality. These APIs may be exposed to the web site or application in the UI thread 402. Through these APIs, the web app may define elements that are drag sources and drop targets, as well as any data transferred in the drag and drop operation. When an element is specified as draggable, the element is processed by the IHT thread 404. In an embodiment that exposes two interaction models to initiate a drag and drop operation with touch input (e.g., press-and-hold and cross-slide gestures), an interaction model is also processed by the IHT thread 404.

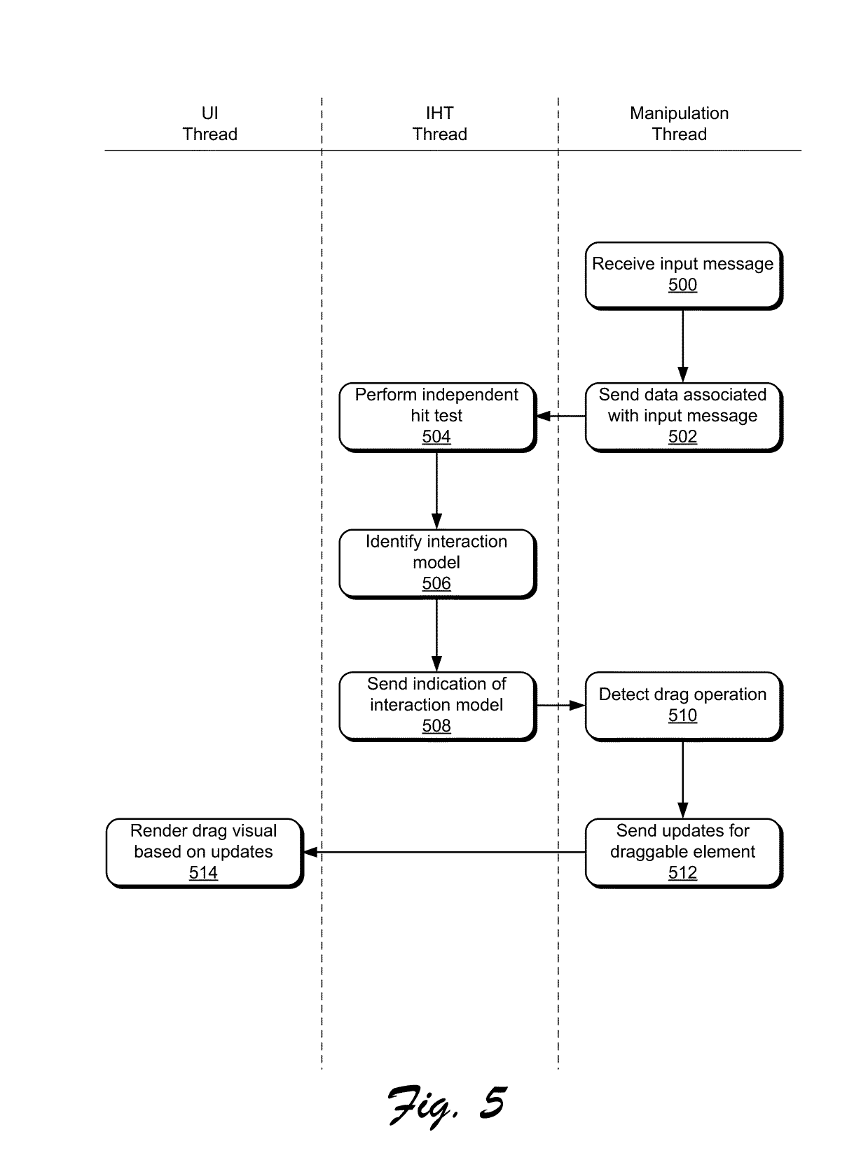

Consider now FIG. 5, which is a flow diagram that describes steps in a method in accordance with one or more embodiments. The method can be implemented in connection with any suitable hardware, software, firmware, or combination thereof. In at least some embodiments, the method can be implemented by a suitably-configured system, such as one that includes an independent hit test thread. In the illustrated example, various aspects of the described method appear in a respective column that is designated by the thread that performs the particular operation, e.g., “UI Thread”, “IHT Thread”, and “Manipulation Thread”.

Step 500 receives, at the manipulation thread, an input message associated with an input. In at least some embodiments, the input comprises a touch input. Other types of inputs, however, can be received without departing from the spirit and scope of the claimed subject matter. In at least some embodiments, the input message is received by the manipulation thread and placed into a queue. Step 502 sends data associated with the input message to an independent hit test (IHT) thread. In one embodiment, the data includes one or more locations of new touch inputs. Responsive to the IHT thread receiving the input message, step 504 performs an independent hit test to determine whether the input has hit a draggable element. In this example, the IHT thread determines the element's drag eligibility by querying the element's state, which can be read from HTML associated with the page. The element's state provides an indication of whether the element is enabled for a particular operation. By way of example and not limitation, a state may indicate that one or more of dragging, panning, or zooming capabilities is enabled for a particular element or viewport.

Responsive to determining that the input has hit a draggable element, step 506 identifies, at the IHT thread, an interaction model configured for the draggable element. The interaction model defines which type of interaction is being initiated by the input. Different types of interaction models may include, by way of example and not limitation, a press-and-hold interaction, a cross-slide interaction, and the like. Step 508 sends an indication of the interaction model to the manipulation thread. Responsive to receiving the indication of the interaction model, the manipulation thread detects at step 510 that a drag operation is triggered. In one or more embodiments, the manipulation thread can use system gesture recognizing components to detect if a drag operation is triggered, based on the indicated interaction mode. These gesture recognizing components may be configured to detect a particular gesture, such as a press-and-hold gesture or a cross-slide gesture, that is operable to trigger a drag operation based on a drag threshold, as described above and below. If a drag operation is triggered, step 512 sends updates for the draggable element to the UI thread. In embodiments, updates are also sent to the UI thread during the drag operation. By way of example and not limitation, the updates may include updates to one or more locations of the draggable element. Based on the updates, step 514 renders a visual representation of the draggable element for display.

According to the above-described architecture, independent manipulation is provided along with dependent drag processing. For example, while a drag preview is being moved around under the user's finger independent of the UI thread 402, processing of the drag operation is dependent on the UI thread 402 because the IHT thread 404 can send the drag messages to the UI thread 402 for processing.

Having considered the above-described multi-threaded architecture and techniques used therewith, consider now a discussion of pre-layering in accordance with one or more embodiments.

Pre-Layering

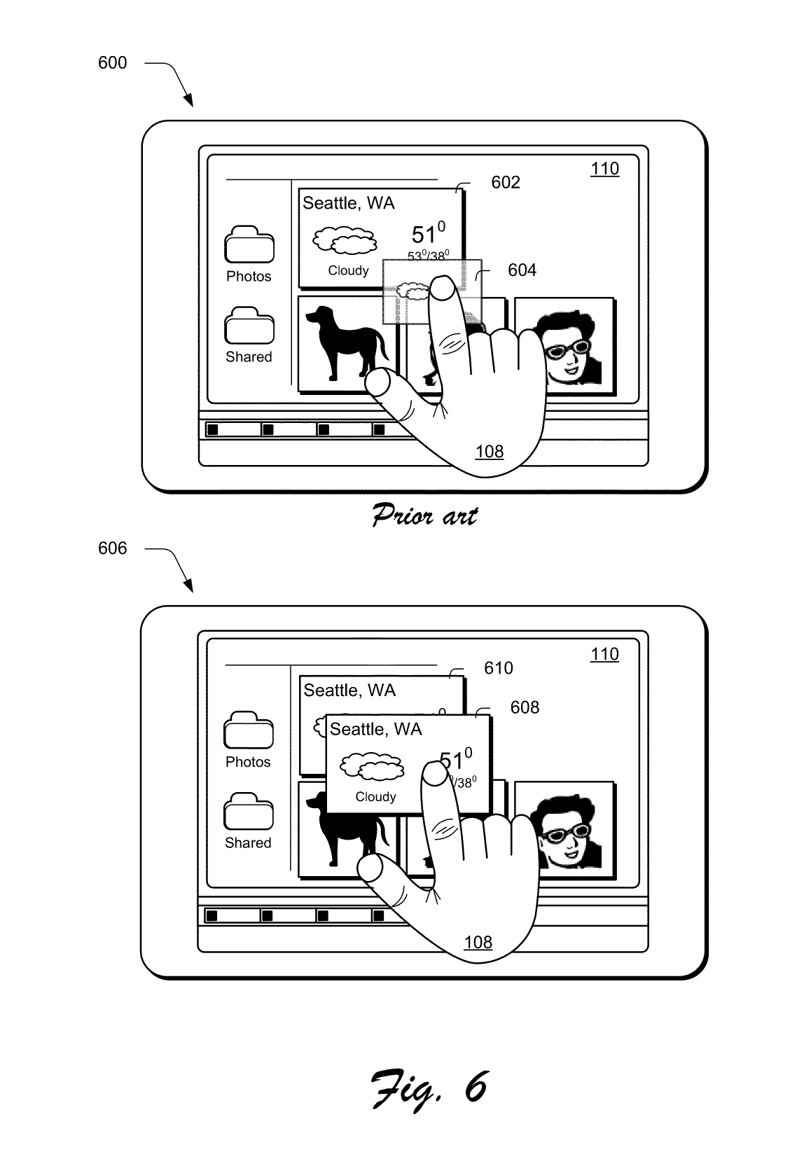

Traditional techniques for dragging an element may produce a draggable representation of the element that is visually altered from the element so as to provide a visual cue that the element is being dragged. However, transitioning from the element to the visually altered draggable representation of the element can, in some instances, produce a jarring or jittered effect thereby resulting in a transition that is not smooth. To overcome this challenge, a drag visual may be provided that is a same visual representation as the element that is selected for dragging. Consider, for example, FIG. 6, which is an illustration of an example implementation in accordance with one or more embodiments. The upper portion 600 of FIG. 6 illustrates traditional techniques for producing a draggable representation of a selected element. For example, element 602 has been selected for dragging by a user and a draggable representation 604 is produced to indicate to the user that the element 602 is being dragged. However, the draggable representation 604 is a visually altered version of the element 602. The draggable representation 604 can be visually altered in various ways. In this example, the draggable representation 604 is altered from the element 602 in size, opacity, and content.

The lower portion 606 of FIG. 6 illustrates a drag visual 608 that is rendered with visual characteristics that match the original visual characteristics of the draggable element 610 that was selected for dragging. Such visual characteristics can include, by way of example and not limitation, size, shape, color, opacity, brightness, content, and so on.

In at least some embodiments, elements that are candidates for dragging are rendered in a separate visual layer in advance of user interaction such as when loading the page, when a new element is created after the page is loaded, when a non-draggable element is altered to become draggable subsequent to the page being loaded, and so on. An element that is a candidate for dragging can comprise an element on the page that is identified as a draggable element such as an element that is capable of being dragged via a drag and drop operation. These draggable elements may include a declarative attribute that identifies the element as “draggable” for a press-and-hold gesture, a cross-slide gesture, or other touch input that initiates a drag and drop operation. Providing a declarative attribute in this way allows the runtime environment to provide a multi-threaded drag and drop experience that leverages existing manipulation technologies to ensure a fast and fluid experience for the user.

By pre-layering draggable elements, the web platform 106 can render the element into a separate draggable viewport on demand without delay should the user initiate a drag operation, thus creating a seamless transition from the element in the page to the drag visual being moved by the user. Additionally, pre-layering draggable elements may reduce lag time that is typically caused by creating the drag visual at the time the drag operation is initiated. In one embodiment, the drag visual may include a static representation of the element when the drag and drop operation is initiated. Additionally or alternatively, the drag visual may include a dynamic representation that continues to be rendered while the element is dragged. The dynamic representation can be maintained by, for example, receiving dynamic visual updates to the drag visual of the element while being dragged.

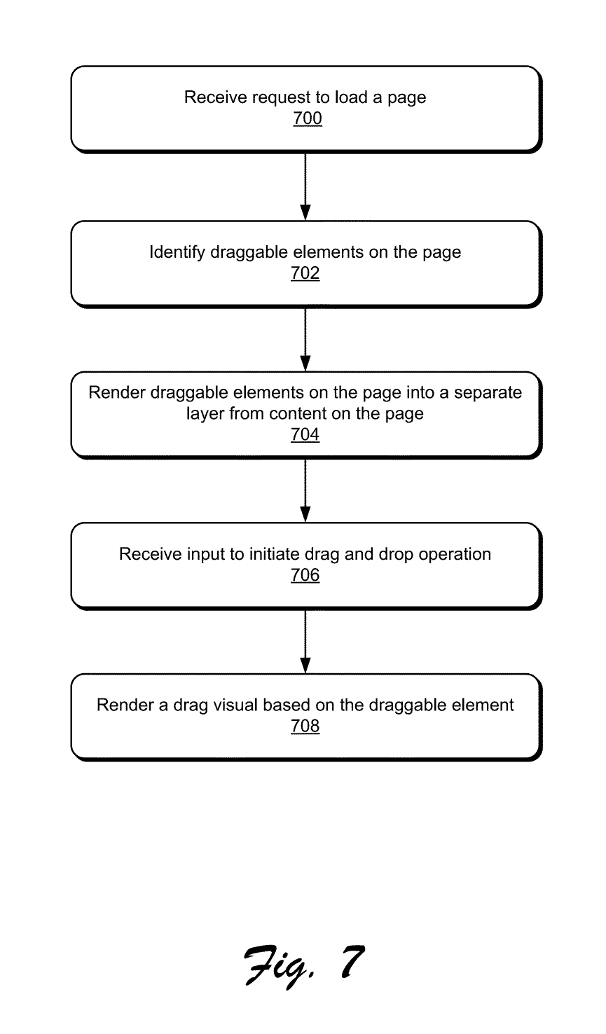

Consider now FIG. 7, which is a flow diagram that describes steps in a method in accordance with one or more embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Non-limiting examples of software components that can perform the functionality about to be described are described just above in FIG. 6, including the gesture module 104 described above.

Step 700 receives a request to load a page. This step can be performed in any suitable way. For example, the request can include a navigation request to navigate to a web page or application. Step 702 identifies draggable elements on the page. Any suitable identification technique may be utilized. In at least some embodiments, an element can include a declarative attribute that identifies the element is drag-enabled. The declarative attribute can also indicate that the element is draggable for a particular gesture, such as a press-and-hold gesture or a cross-slide gesture, as described above.

Step 704 renders draggable elements on the page into a separate layer from content on the page. This step can be performed in any suitable way. In one or more embodiments, the draggable elements are pre-layered into a visual layer that is separate from another layer in which other content on the page is rendered. Step 706 receives an input to initiate a drag and drop operation. Any suitably configured input can be utilized. In at least some embodiments, the input may include a touch input, such as a press-and-hold gesture or a cross-slide gesture, as described above. In response to the drag and drop operation being initiated, step 708 renders a drag visual based on the draggable element. This step can be performed in any suitable way. In one or more embodiments, the drag visual visually matches the draggable element. Because the draggable element is pre-layered into a separate layer, the drag visual can be generated and rendered on demand without delay, thus creating a seamless transition from the element to the drag visual.

Having considered techniques for pre-layering draggable elements, consider now a discussion of mapping touch input to mouse-intended drag drop APIs in accordance with one or more embodiments.

Mapping of Touch Input to Mouse-Intended Drag Drop APIs

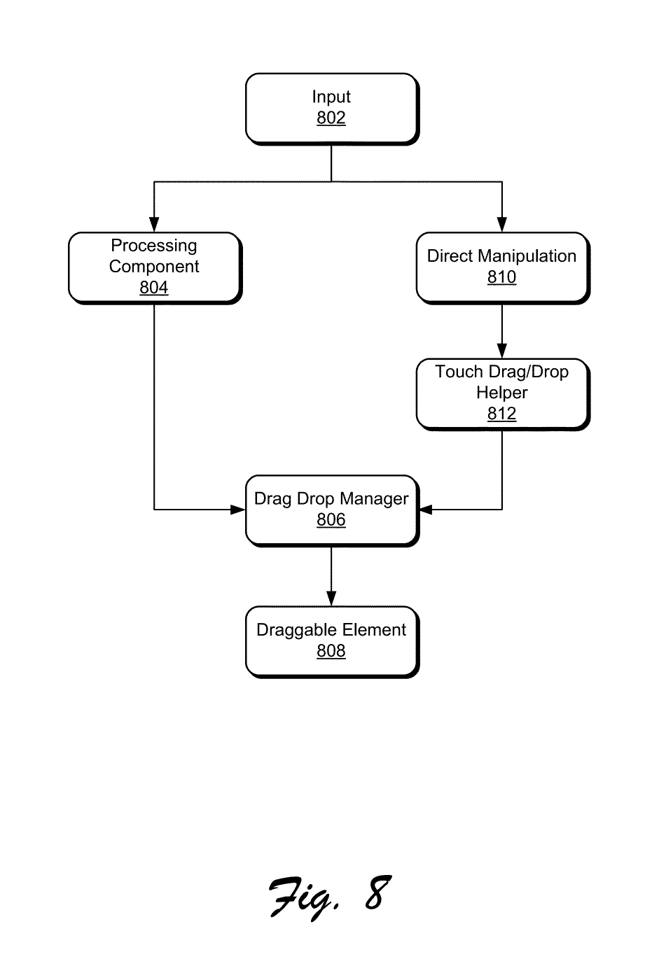

FIG. 8 illustrates an example architecture for receiving and processing mouse and touch inputs. For example, an input 802 is received, and if the input causes a mouse message to be produced, the mouse message is sent to a processing component 804 to determine whether the mouse message is configured to initiate a drag and drop operation. Any suitably-configured processing component can be utilized. In at least some embodiments, the processing component can comprise an Object Linking and Embedding (OLE) component. Other components can be utilized without departing from the spirit and scope of the claimed subject matter. Based on determining that the mouse message is a drag input, processing component 804 sends one or more drag notifications to a drag drop manager 806. The drag drop manager 806 then determines, based on the drag notifications, that the element is a draggable element, and initiates a drag and drop operation on the draggable element.

If, however, the received input 802 is a touch input that causes a pointer message to be produced, the pointer message is sent to a direct manipulation component 810 to determine whether the pointer message is configured to initiate a drag and drop operation. Based on determining that the pointer message is a drag input, the direct manipulation component 810 sends manipulation notifications to a touch drag/drop helper 812. In at least some embodiments, the touch drag/drop helper 812 is configured to correlate updates from the direct manipulation component 810 with a drag visual that represents the element. The touch drag/drop helper 812 is further configured to send drag notifications to the drag drop manager 806. These drag notifications are an emulation of drag notifications typically provided by the processing component 804 for mouse based drag and drop operations, facilitating backwards compatibility for touch users to use drag and drop functionality in web sites/apps designed for mouse.

In one or more embodiments, the touch drag/drop helper 812 maps the touch inputs to mouse-compatible functionalities for the drag drop manager 806 so that the drag drop manager 806 does not have to understand the touch inputs. Rather, the drag drop manager 806 simply initiates functionalities associated with the drag notifications regardless of whether the drag notifications are generated by the touch drag/drop helper 812 from the touch inputs or by processing component 804 from the mouse inputs.

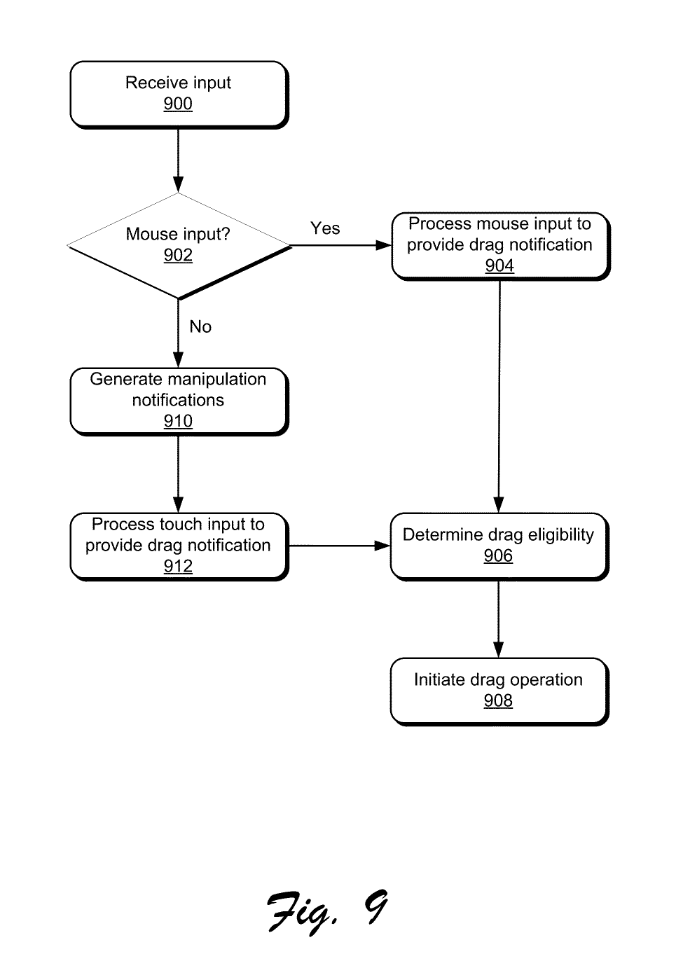

Consider now FIG. 9, which is a flow diagram that describes steps in an input transformation process or method in accordance with one or more embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Non-limiting examples of software components that can perform the functionality about to be described are described just above in FIG. 8, including the gesture module 104 described above.

Step 900 receives an input. This step can be performed in any suitable way. For example, the input can be received relative to an element that appears on a display device. Any suitable type of element can be the subject of the input. Step 902 determines whether the input comprises a mouse input or other type of input, such as a touch input. Any suitable type of determination scenario may be utilized. If the input is determined to be a mouse input, then step 904 processes the mouse input to provide one or more drag notifications that include data associated with the element. Such data can include, by way of example and not limitation, drag state and data transfer information. Step 906 determines drag eligibility from the drag notifications.

If the element is eligible for dragging, then step 908 initiates and executes the drag operation. If, on the other hand, the element is not eligible for dragging, then one of various other operations can be initiated and executed such as, for example, selection of the element or activation of a link. In other embodiments, nothing may happen if the element is not eligible for dragging.

If the input is not a mouse input, and step 902 determines that the input is some other type of input, such as a touch input, then step 910 generates manipulation notifications associated with the touch input. This step can be performed in any suitable way. For example, manipulation notifications may be generated that include data associated with manipulation of the element, such as movement of the element to a new location. Step 912 uses the manipulation notifications to process the touch input to provide one or more drag notifications. These drag notifications include data associated with the element that is the subject of the touch input. Such data can include, by way of example and not limitation, drag state and data transfer information. The drag notifications based on the touch input are then used, similar to the drag notifications for the mouse input, to determine drag eligibility of the element in step 906. Step 908 then initiates the drag operation based on the element being eligible for dragging.

Having considered the above-described mapping techniques, consider now a discussion of independent automatic scrolling in accordance with one or more embodiments.

Method/Gesture for Independent Automatic Scrolling

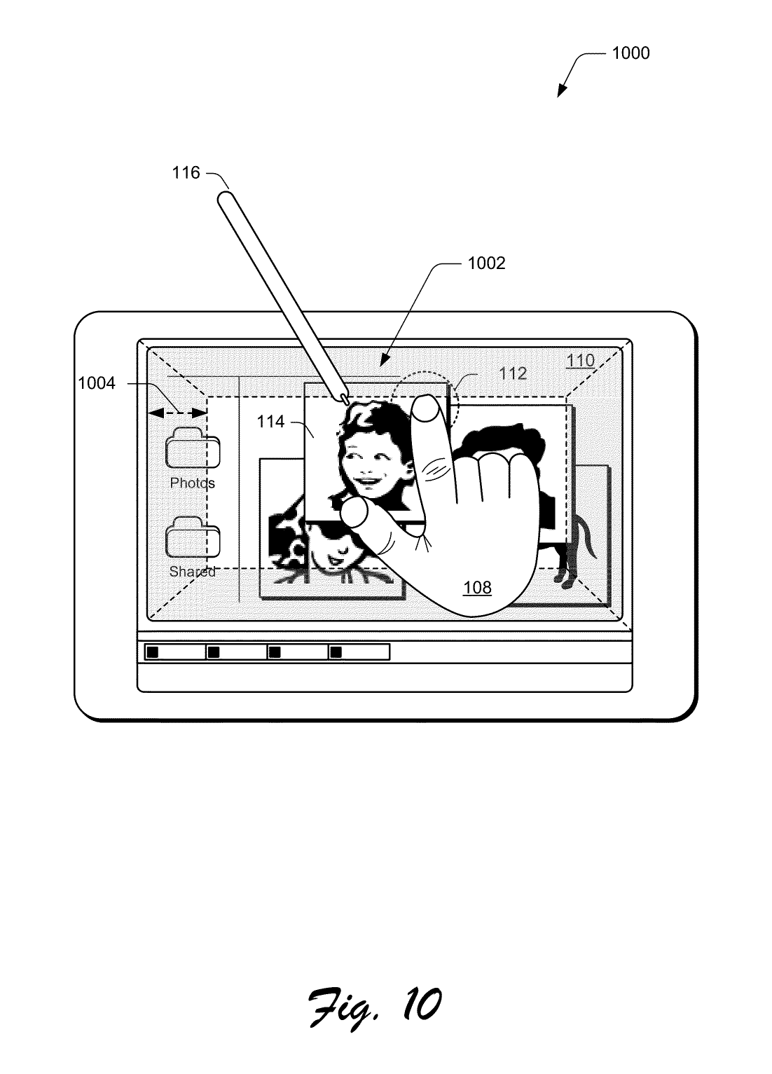

FIG. 10 illustrates a system 1000 showing an example implementation that is operable to employ automatic scrolling for a touch input. When dragging an element with a touch input, the user may intend to drop the element on a target that is not currently visible. For example, the target location may be hidden off-screen in a scrollable region. In at least some embodiments, the user may trigger automatic scrolling of a scrollable region by dragging the element near an edge of the scrollable region. For example, the user may drag the element within a region such as the crosshatched area 1002 of FIG. 10 to trigger the automatic scrolling. Automatic scrolling can be performed in any suitable way. For example, the scrolling may be triggered and performed independent of the application's running code. In at least some other embodiments, messages may be sent to an application to instruct the application to initiate scrolling. The application, however, may be required to respond to such messages and perform the scrolling itself, which may introduce lag if the application is already processing other operations.

Continuing with the above example where the drop target is located inside a scrollable container and is not currently visible, the IHT thread 404, described above with respect to FIG. 4, may be configured to be cognizant of scrollable viewports in addition to draggable viewports. In this particular example, the manipulation thread 406 can provide updates for a drag visual to the IHT thread 404. The IHT thread 404 can then instruct the manipulation thread 406 to scroll viewports underneath the drag visual. To enable users to reveal hidden drop targets, a distance threshold 1004 may be established around a perimeter of one or more scrollable viewports on the page. Any suitable distance threshold may be utilized. For example, the distance threshold 1004 can include a sufficient distance to provide sufficient space for a size of a typical finger. In at least some embodiments, the distance threshold 1004 can comprise approximately 100 pixels.

When the drag visual enters a region of a scrollable viewport such as an auto-scroll region within the distance threshold 1004, the scrollable viewport begins scrolling in that edge direction. Further, in order to avoid accidental triggering of scrolling regions while dragging across the application, a minimum time threshold may be established for which the draggable element lingers in the auto-scroll region. Any suitable time threshold may be utilized. In at least some embodiments, a time threshold may include a value within a range of 200-500 milliseconds.

In addition, the automatic scrolling of the scrollable region may be canceled responsive to the user dragging the element away from the edge and outside of the auto-scroll region. For example, during execution of the automatic scrolling, the target drop may be scrolled into view. In order to avoid scrolling passed the target drop, the user can drag the element away from the edge of the scrollable region, such as toward the center of the screen. By dragging the element outside of the distance threshold for the scrollable region, the automatic scrolling is terminated, and the user can then drop the element at the target drop.

Having considered the above-described techniques for independent automatic scrolling, consider now a discussion of z-order transitions in accordance with one or more embodiments.

Smooth Transitions of Z-Order

When a drag gesture is triggered, a drag visual representing the element is produced for the user to re-arrange. The drag visual may substantially resemble the appearance of the original element. Further, the drag visual can be rendered at a top layer, or z-index, to prevent the drag visual from being clipped by other elements on the page. In traditional techniques, transitioning from the element to the drag visual is typically apparent to the user due to a momentary glitch in the rendering as the original element snaps back to its original location and a new visual appears under the user's finger. Using high performance touch drag and drop, however, the transition from the element to the drag visual is smooth.

To ensure that the draggable element is not occluded during dragging, a z-index is enforced at the time that drag and drop operation is initiated to maintain the draggable element on the top layer. In at least some embodiments, a transition animation may be applied that fades the element out in its original z-index and fades the drag visual in at a new z-index to reduce a visual “pop” that would otherwise occur if the element is initially occluded. Alternatively or in addition, the transition animation may last longer than two vertical blanking intervals in order to hide the glitch.

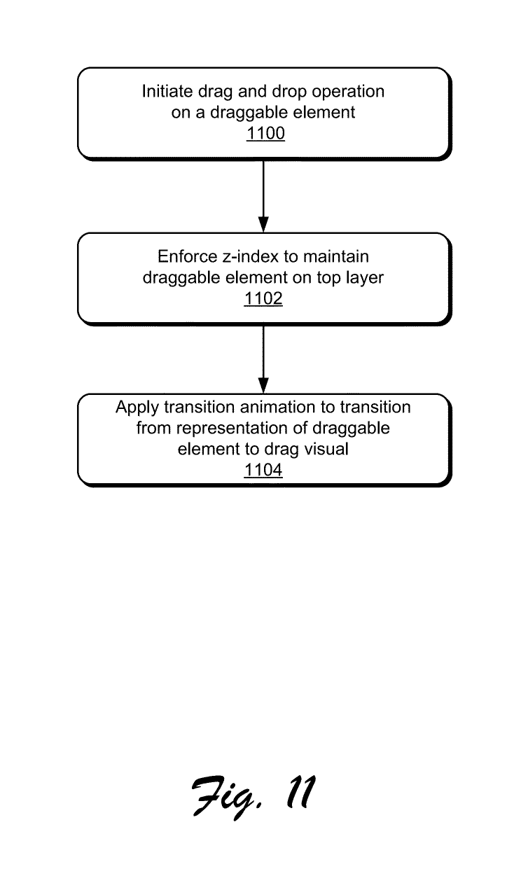

Consider now FIG. 11, which is a flow diagram that describes steps in a method in accordance with one or more embodiments. The method can be implemented in connection with any suitable hardware, software, firmware, or combination thereof. In at least some embodiments, the method can be performed by software in the form of computer readable instructions, embodied on some type of computer-readable storage medium, which can be performed under the influence of one or more processors. Non-limiting examples of software components that can perform the functionality about to be described are described just above in FIG. 1, including the gesture module 104 described above.

Step 1100 initiates a drag and drop operation on a draggable element. This step can be performed in any suitable way. For example, the drag and drop operation can be initiated by a touch input interacting with the draggable element, such as the press-and-hold or cross-slide gestures described above. Step 1102 enforces a z-index to maintain the draggable element on a top layer. Any suitable type of enforcement scenario may be utilized. Enforcement of the z-index of the draggable element can prevent the drag visual from being clipped by other elements on the page as the draggable element is being dragged. Step 1104 applies a transition animation to transition from a representation of the draggable element to a drag visual. Any suitable transition can be utilized, such as those described above.

Having described methods and systems for high performance touch drag and drop, consider now an example device that can be utilized to implement one or more embodiments described above.

### Example Device

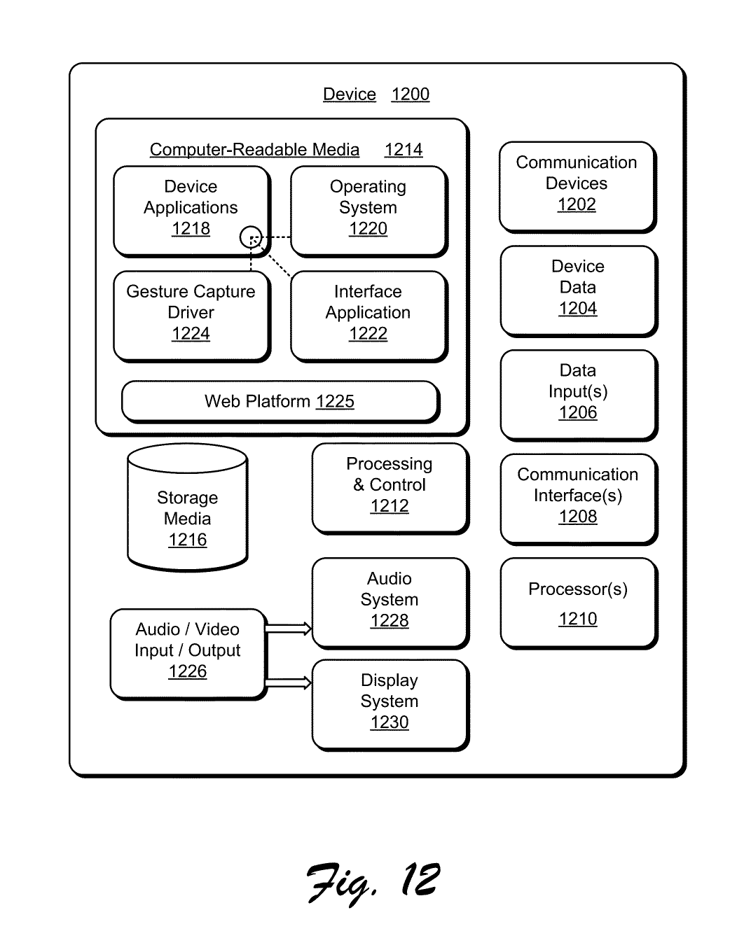

FIG. 12 illustrates various components of an example device 1200 that can be implemented as any type of computing device as described with reference to FIGS. 1 and 2 to implement embodiments of the techniques described herein. Device 1200 includes communication devices 1202 that enable wired and/or wireless communication of device data 1204 (e.g., received data, data that is being received, data scheduled for broadcast, data packets of the data, etc.). The device data 1204 or other device content can include configuration settings of the device, media content stored on the device, and/or information associated with a user of the device. Media content stored on device 1200 can include any type of audio, video, and/or image data. Device 1200 includes one or more data inputs 1206 via which any type of data, media content, and/or inputs can be received, such as user-selectable inputs, messages, music, television media content, recorded video content, and any other type of audio, video, and/or image data received from any content and/or data source.

Device 1200 also includes communication interfaces 1208 that can be implemented as any one or more of a serial and/or parallel interface, a wireless interface, any type of network interface, a modem, and as any other type of communication interface. The communication interfaces 1208 provide a connection and/or communication links between device 1200 and a communication network by which other electronic, computing, and communication devices communicate data with device 1200.

Device 1200 includes one or more processors 1210 (e.g., any of microprocessors, controllers, and the like) which process various computer-executable instructions to control the operation of device 1200 and to implement embodiments of the techniques described herein. Alternatively or in addition, device 1200 can be implemented with any one or combination of hardware, firmware, or fixed logic circuitry that is implemented in connection with processing and control circuits which are generally identified at 1212. Although not shown, device 1200 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1200 also includes computer-readable media 1214, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1200 can also include a mass storage media device 1216.

Computer-readable media 1214 provides data storage mechanisms to store the device data 1204, as well as various device applications 1218 and any other types of information and/or data related to operational aspects of device 1200. For example, an operating system 1220 can be maintained as a computer application with the computer-readable media 1214 and executed on processors 1210. The device applications 1218 can include a device manager (e.g., a control application, software application, signal processing and control module, code that is native to a particular device, a hardware abstraction layer for a particular device, etc.). The device applications 1218 also include any system components or modules to implement embodiments of the techniques described herein. In this example, the device applications 1218 include an interface application 1222 and a gesture capture driver 1224 that are shown as software modules and/or computer applications. The gesture capture driver 1224 is representative of software that is used to provide an interface with a device configured to capture a gesture, such as a touchscreen, track pad, camera, and so on. Alternatively or in addition, the interface application 1222 and the gesture capture driver 1224 can be implemented as hardware, software, firmware, or any combination thereof. Additionally, computer readable media 1214 can include a web platform 1225 that functions as described above.

Device 1200 also includes an audio and/or video input-output system 1226 that provides audio data to an audio system 1228 and/or provides video data to a display system 1230. The audio system 1228 and/or the display system 1230 can include any devices that process, display, and/or otherwise render audio, video, and image data. Video signals and audio signals can be communicated from device 1200 to an audio device and/or to a display device via an RF (radio frequency) link, S-video link, composite video link, component video link, DVI (digital video interface), analog audio connection, or other similar communication link. In an embodiment, the audio system 1228 and/or the display system 1230 are implemented as external components to device 1200. Alternatively, the audio system 1228 and/or the display system 1230 are implemented as integrated components of example device 1200.

### CONCLUSION

High performance touch drag and drop techniques are described. In at least some embodiments, a multi-threaded architecture is implemented to include at least a manipulation thread and an independent hit test thread. The manipulation thread receives messages associated with an input, and sends data associated with the messages to the independent hit test thread. The independent hit test thread performs an independent hit test to determine whether the input hit an element that is eligible for a particular action. The independent hit test thread also identifies an interaction model associated with the input, and sends an indication of the interaction model to the manipulation thread to enable the manipulation thread to detect whether the particular action is triggered.

In one or more embodiments, one or more manipulation notifications based on a pointer message associated with a touch input are received. The pointer message is configured to initiate a drag and drop operation on an element of a page. Updates associated with the pointer message are correlated with a drag visual that represents the element on the page. One or more drag notifications are sent to a drag drop manager to enable the drag drop manager to initiate mouse-compatible functionalities without having to understand the touch input.

In at least some embodiments, a request to load a page is received, and one or more draggable elements on the page are identified. The draggable elements are rendered on the page into a layer that is separate from another layer into which content on the page is rendered. An input to initiate a drag and drop operation on a draggable element is received. Responsive to the drag and drop operation being initiated, a drag visual is rendered based on the draggable element.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
a memory and a processor configured to execute instructions stored in the memory to implement a multi-threaded architecture, the multi-threaded architecture comprising:
a manipulation thread configured to:
receive one or more messages associated with an input; and
send data associated with the one or more messages to an independent hit test (IHT) thread; and
the IHT thread configured to:
perform an independent hit test to determine whether the input was received relative to an element that is eligible for a particular action;
identify an interaction model associated with the input; and
send to the manipulation thread an indication of the interaction model, the indication of the interaction model being usable to detect whether the particular action is triggered.

2. A system as described in claim 1, wherein the particular action comprises a dragging operation, wherein the IHT thread is configured to determine whether the element is eligible for the dragging operation by at least querying a state of the element for an indication that the element is drag-enabled.

3. A system as described in claim 1, further comprising a web platform configured to expose one or more application programming interfaces (APIs) to a web site in a user interface thread, the one or more APIs configured to define one or more elements on a page as drag sources or drop targets.

4. A system as described in claim 1, wherein the independent hit test thread is configured to forward the one or more messages to a user interface thread without blocking manipulation operations performed by the manipulation thread.

5. A system as described in claim 1, wherein the interaction model includes one of a press-and-hold interaction or a cross-slide interaction.

6. A system as described in claim 1, wherein the manipulation thread is further configured to:
detect that a drag operation is triggered;
identify updates for the element, the updates associated with the drag operation; and
send the updates for the element to a user interface thread for rendering the element based on the updates.

7. A system as described in claim 1, wherein the manipulation thread is further configured to utilize one or more gesture recognizing components to detect a particular gesture that is operable to trigger the particular action.

8. One or more computer readable storage media having instructions stored thereon that, responsive to execution by a computing device, cause the computing device to implement a touch drag/drop helper module configured to:
receive one or more manipulation notifications based on a pointer message associated with a touch input, the pointer message configured to initiate a drag and drop operation on an element of a page;
correlate updates associated with the pointer message with a drag visual that represents the element on the page; and
send one or more drag notifications to a drag drop manager, the drag notifications configured to enable the drag drop manager to initiate one or more mouse-compatible functionalities without having to understand the touch input.

9. One or more computer readable storage media as described in claim 8, wherein the touch input comprises a press-and-hold gesture or a cross-slide gesture.

10. One or more computer readable storage media as described in claim 8, wherein the one or more manipulation notifications include data associated with manipulation of the element, the manipulation of the element comprising movement of the element to a new location.

11. One or more computer readable storage media as described in claim 8, wherein the one or more drag notifications include data associated with the element, the data including a drag state of the element and data transfer information.

12. One or more computer readable storage media as described in claim 8, wherein the one or more drag notifications are usable to determine drag eligibility of the element.

13. A method comprising:
identifying one or more draggable elements on a page;
rendering the one or more draggable elements on the page into a layer that is separate from another layer into which content on the page is rendered;
receiving an input to initiate a drag and drop operation on a draggable element; and
responsive to the drag and drop operation being initiated, rendering a drag visual based on the draggable element.

14. A method as described in claim 13, wherein the layer comprises a top layer.

15. A method as described in claim 13, further comprising enforcing a z-index to maintain the draggable element on a top layer

16. A method as described in claim 13, further comprising applying a transition animation to transition from a representation of the draggable element to the drag visual.

17. A method as described in claim 13, wherein the drag visual visually matches the draggable element.

18. A method as described in claim 13, further comprising:
receiving an input to drag the draggable element into a region of a scrollable viewport;
responsive to the drag visual being maintained in the region of the scrollable viewport for a duration of time that exceeds a threshold, automatically scrolling the region.

19. A method as described in claim 13, further comprising:
receiving an additional input associated with a scroll-enabled element, the additional input being received in parallel with execution of the drag and drop operation; and
initiate a panning operation to pan the page concurrently with the draggable element being dragged.

20. A method as described in claim 13, further comprising determining a gesture type of the input, the gesture type including one of a press-and-hold gesture or a cross-slide gesture.
